(19) United States
(12) Patent Application Publication
(10) Pub. No.: US 2016/0283927 A1
(43) Pub. Date: Sep. 29, 2016

(54) AUTHENTICATION FOR MOBILE TRANSACTIONS

(71) Applicant: MasterCard International Incorporated, Purchase, NY (US)

(72) Inventors: Aaron Smith, Woodley (GB); Mark Britten, Sevenoaks (GB)

(21) Appl. No.: 15/077,078

(22) Filed: Mar. 22, 2016

(30) Foreign Application Priority Data
Mar. 24, 2015 (GB) 1504983.6

(51) Int. Cl. G06Q 20/20; H04W 4/02; G06Q 20/32; G06Q 20/40; G06Q 20/38

(52) U.S. Cl. CPC G06Q 20/20; G06Q 20/401; G06Q 20/3821; G06Q 20/3224; H04W 4/02; G06Q 50/01

(57) ABSTRACT

A computer implemented method of authenticating one or more parties to a transaction is provided. A first party to the transaction is registered with an information service trusted by the first party and a second party. The information service holds credential data for the first party as a result of this registration. Location data for the first party is provided to the information service. When the second party wishes to transact with the first party, the information service provides the location data for the first party and the credential data for the first party to the second party. A suitable information service is also provided, together with a mobile point of sale terminal and a user mobile device for use in this approach to transaction authentication.

### CROSS-REFERENCED TO RELATED APPLICATION

This application is a U.S. National Stage filing under 35 U.S.C. §119, based on and claiming benefit of and priority of GB Patent Application No. 1504983.6 filed Mar. 24, 2015.

### FILED OF DISCLOSURE

to This disclosure relates generally to authentication for mobile transactions. In embodiments, it relates to mobile devices acting as payment solutions or mobile Point of Sale terminals (MPOS) and to methods and apparatus for consumers transacting with these terminals to ensure that the transaction meets consumer intentions.

### BACKGROUND OF DISCLOSURE

Payment cards such as credit cards and debit cards are very widely used for all forms of financial transaction. The use of payment cards has evolved significantly with technological developments over recent years. Originally, transactions were on paper, using an imprint of a transaction card and confirmed by a signature. This approach was largely replaced by use of a magnetic stripe of a transaction card swiped through a magnetic stripe reader on a point of sale (POS) terminal to perform a transaction. Transaction cards developed to contain an integrated circuit (“chip cards” or “smart cards”) that communicates with a smart card reader in the POS terminal. Using this approach, a transaction is typically confirmed by a personal identification number (PIN) entered by the card user. Cards of this type typically operate under the EMV standard for interoperation of chip cards and associated apparatus (such as POS terminals and ATMs). ISO/IEC 7816 provides a standard for operation of cards of this type.

Technology has further developed to provide payment cards which operate contactlessly—under EMV, these are covered under the ISO/IEC 14443 standard.

Using such cards, the primary account number (PAN) can be read automatically from the card by a POS terminal, generally using a short range wireless technology such as NearField Communications (NFC)—this approach is generally referred to as “contactless” or “proximity” payment. This is typically enabled by embedding of an NFC chip in a card body together with a suitable antenna to allow transmission and receipt of wireless signals—the transmissions may be powered by a magnetic inductive field emitted by a proximity reader in the POS terminal. For an effective transaction to be made; the payment card may need to be brought into close proximity to the proximity reader—EMVCo has defined this range under the Level 1 operating volume range of 0-4 cm.

The present applicants have developed a proprietary system, known as PayPass® for performing contactless transactions. The present applicants have also appreciated that it would be possible to use a computing device such as a consumer mobile device as a proxy for a payment card. They have also developed a mobile payment application, Mobile PayPass™ (also known as MCM—Mchip Mobile), which can be securely provisioned to a consumer mobile device (hereafter “mobile phone”) to act as a proxy for a payment card using Near Field Communication (NFC) technology standards, which are built in to the majority of current mobile phones. Using Mobile PayPass™, a user their mobile phone to conduct ‘tapping based’ transactions against a proximity reader, as well as perform account management operations over an appropriate network interface (cellular, local wireless network) in an online banking interface with the user's account provider. A user may now commonly use his or her mobile phone in obtaining banking services, both in mobile payment (such as by use of Mobile PayPass™) and also in locating ATMs and participating merchants (which can be done for MasterCard with MasterCard Nearby™). Other payment technologies for mobile use exist—the present applicant uses an HCE (host card emulation) solution MCBP (MasterCard Cloud Based Payments), MasterPass and DSRP (Digital Secure Remote Payment).

A key feature of any banking transaction is trust—the user, the merchant, and the banking infrastructure provider must all have a satisfactory basis for trustingeach other to the degree necessary for each party to have confidence in a transaction. As the payment infrastructure becomes more flexible but also more complex, it also becomes more difficult to protect the system and all its users against subversion and fraud. Generally, a user will trust ATMs and merchants because they will be given security by the local built environment (bricks & mortar)—the user will be located in a user's physical store, or the ATM will be attached to a bank or another trusted location—but this model of trust breaks down for a merchant point of sale device that is itself mobile (a mobile POS or MPOS).

MPOS terminals can allow merchants to transact away from a specific location in the built environment, and the combination of flexibility and low cost of ownership offered by an MPOS terminal enable an increasing range of parties to act as merchants. This does, however, create a problem for customers. A customer needs to place a high level of trust in a POS terminal, as providing card information and credentials to an untrustworthy POS terminal could result in severe financial loss. It is however difficult to for a customer to place the same level of trust in an MPOS terminal as a customer would have for a conventional POS terminal in a physical store.

It would be desirable to have a mechanism that allowed users to have greater confidence that they were interacting with legitimate merchants using trustworthy terminals—in particular, it would be desirable to enable a mobile user to have greater confidence that an MPOS terminal was authenticated to be trustworthy.

### SUMMARY OF DISCLOSURE

In a first aspect, the disclosure provides a computer implemented method of authenticating one or more parties to a transaction, comprising: registering at least a first party to the transaction with an information service trusted by the first party and a second party, whereupon the information service holds credential data for the first party; providing location data for the first party to the information service; and when the second party wishes to transact with the first party, the information service providing the location data for the first party and the credential data for the first party to the second party.

This approach provides the second party with greater confidence that the first party being transacted with is indeed the first party that it appears to be. In embodiments, the first party comprises a mobile point-of-sale terminal. The location data may be provided by one or more of GPS, cellular telephony cell data and local wireless network location data associated with the first party.

The second party may comprise a mobile computing device or a mobile handset. In this case, the location data may be provided for use to illustrate a map location for the first party, for example so that the map location of the first party is provided to be shown on a local transaction services map.

The location data may even be used to determine when the first party and the second party are co-located. In such a case, a transaction prompt may be provided when it is determined that the first party and the second party are co-located.

In embodiments, the credential data is a visual indicator, such as a picture of a person associated with the first party.

In embodiments, the information service may also hold social media data for the first party and provides the social media data when providing the location data and the credential data.

In a second aspect, the disclosure provides an information service system for providing information relating to transactions, wherein the information service comprises a computing system with processing apparatus, network communication to send information to and receive information from other parties and memory, wherein the information service is adapted to: receive registration data from transaction apparatus parties, the registration data comprising transaction apparatus party data and at least one party credential data, receive location data from the transaction apparatus parties, and provide location data and credential data for transaction apparatus parties to users of the information service.

The transaction apparatus may comprise a mobile point-of-sale terminal, and users of the information service may comprise mobile computing devices and mobile handsets. The location data may be provided to illustrate a map location for the transaction apparatus, for example with the map location of the transaction apparatus shown on a local transaction services map.

The information service system may be adapted to receive updated credential data for registered transaction apparatus. The credential data may be a visual indicator, such as a picture of a person associated with the first party. The registration data may also comprise social media data associated with the first party and provide the social media data when providing the location data and the credential data.

In a third aspect, the disclosure provides a method for a user mobile device to enable transaction with a point-of-sale terminal, wherein the user mobile device is a mobile computing device or a mobile handset, the method comprising: the user mobile device obtaining location data and credential data for the point-of-sale terminal from a remote trusted source; the user device determining a match between a user location and the point-of-sale terminal location, and the user device providing an indication to a user to allow user determination of whether the credential data is satisfactory; wherein the transaction is enabled if the user location and the point-of-sale terminal location match and the credential data is determined to be satisfactory.

The point-of-sale terminal location may be used within a local transaction services map. The credential data may be a visual indicator, such as a picture of a person associated with the point-of-sale terminal. The user mobile device may receive with the location data social media data associated with the point-of-sale terminal. The user mobile device may store transaction history including information to identify the point-of-sale terminal. The social media data associated with the point-of-sale terminal may be stored in the transaction history.

In a fourth aspect, the disclosure provides a computer program stored on a storage medium, wherein the computer program when stored in a memory of a user mobile device and running on a processor of the user mobile device causes the user mobile device to perform the method described above.

In a fifth aspect, the disclosure provides a user mobile device comprising a processor and a memory and adapted to perform the method described above.

Such a user mobile device may also be adapted for use as a payment device. The user mobile device may be a mobile computing device such as a mobile handset.

In a sixth aspect, the disclosure provides a point-of-sale terminal comprising a mobile point-of-sale device, wherein the point-of-sale terminal is registered with an information service to provide transaction service location data and credential data for the mobile point-of-sale device to users, and wherein the point-of-sale terminal is adapted to provide location data for the mobile point-of-sale device to the information service.

The point-of-sale terminal may also be adapted to provide updated credential data to the information service after registration with the information service.

In a seventh aspect, the disclosure provides a method for enabling social media reviews at a user mobile device, comprising: the mobile user device receiving information comprising location data and social media data for a merchant from an information service and displaying the merchant on a transaction services map, the mobile user device performing or enabling a transaction using the information received from the information service to perform a transaction, and recording the transaction in a transaction history together with the social media information for the merchant, and presenting the transaction history to a user of the user mobile device to allow the user to provide a social media review of the merchant using the social media data for the merchant.

### BRIEF DESCRIPTION OF FIGURES

Embodiments of the disclosure will now be described, by way of example, with reference to the accompanying Figures, of which:

FIG. 1 shows schematically relevant parts of a representative transaction system suitable for implementing an embodiment of the disclosure;

FIGS. 2a, 2b and 2c illustrate schematically relevant functions of a user mobile phone, a mobile services server, and an MPOS terminal, all suitable for implementing an embodiment of the disclosure;

FIG. 3 shows a mobile phone user interface for an existing transaction service location application suitable for modification for implementing an embodiment of the disclosure;

FIG. 4 describes a method according to a broad aspect of the disclosure;

FIG. 5 illustrates a registration process for an MPOS terminal in one aspect of the disclosure;

FIG. 6 illustrates monitoring of MPOS terminal position by an information service associated with the banking infrastructure in an embodiment of the disclosure;

FIGS. 7a and 7b illustrate a mobile phone user interface for a transaction service location application accessing MPOS location data according to an embodiment of the disclosure—FIG. 7a shows nearby MPOS terminals with credential data, whereas FIG. 7b indicates that the user and the MPOS terminal are collocated; and

FIG. 8 illustrates steps in a transaction between a mobile user and an MPOS terminal according to an aspect of the disclosure.

### DESCRIPTION OF SPECIFIC EMBODIMENTS

Specific embodiments of the disclosure will be described below with reference to the Figures.

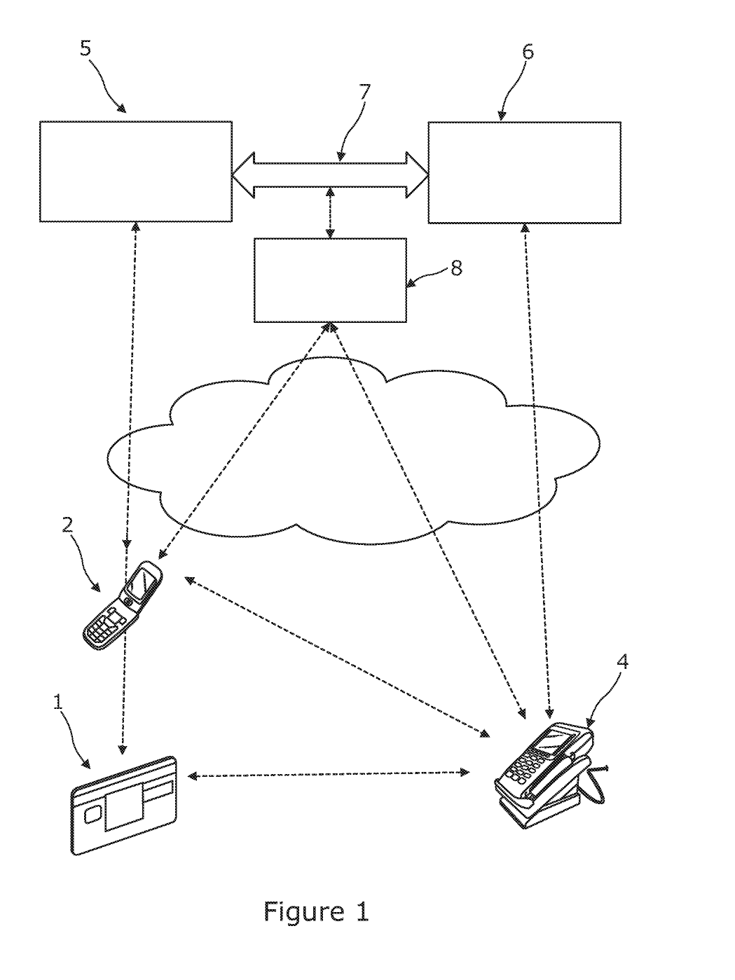

FIG. 1 shows schematically relevant parts of a representative transaction system suitable for implementing an embodiment of the disclosure.

A user (not shown) is provided with a payment device—this may be for example a payment card 1, but in particular embodiments it may be a mobile phone 2 (or other mobile computing device). These devices typically have secure processors and memories for storing information including firmware and applications run by the respective processors. A payment device that is not itself a payment card may be used with an appropriate application as a payment card proxy. Payment cards and payment card proxies will typically be equipped with means to communicate with other elements of a payment infrastructure. These communication means may comprise contacts on a payment card 1 to allow communication by protocols such as those defined under ISO/IEC 7816, they may comprise antennae and associated hardware and software to enable communication by NFC and associated contactless card protocols such as those defined under ISO/IEC 14443, or they may comprise an antenna and associated hardware and software to allow local wireless networking using 802.11 protocols, any combination of the above or any wireless communications protocol.

Other computer equipment in a conventional infrastructure is typically fixed, but in cases of interest point of interaction (POI) terminals 4 may also be mobile. The example shown is a mobile point-of-sale (MPOS) terminal used by a merchant interacting with the user. Such equipment is typically connected or connectable to an acquiring bank 6 or other system in a secure way (either through a dedicated channel or through a secure communication mechanism over a public or insecure channel). There may also be a mechanism to allow connection between the user computer devices and a card issuing bank 5 or system associated with the user. A banking infrastructure 7 will also connect the card issuer 5 and the acquiring bank 6, allowing transactions to be carried out between them.

Associated with the banking infrastructure 7 there can also be a mobile services server 8 (while represented here as a single server, this may of course comprise any appropriate computer system or set of computer systems). The mobile services server 8 may be considered a part of the banking infrastructure 7—it is either integral with it or bound to it in a close trust relationship, so that the banking infrastructure 7 can effectively warrant that communications by other parties with the mobile services server 8 can be trusted. This means that if the other party trusts the banking infrastructure 7, then the other party should also trust the mobile services server 8. The mobile services server 8 is shown as interacting with both the user mobile phone 2 and the MPOS terminal 4.

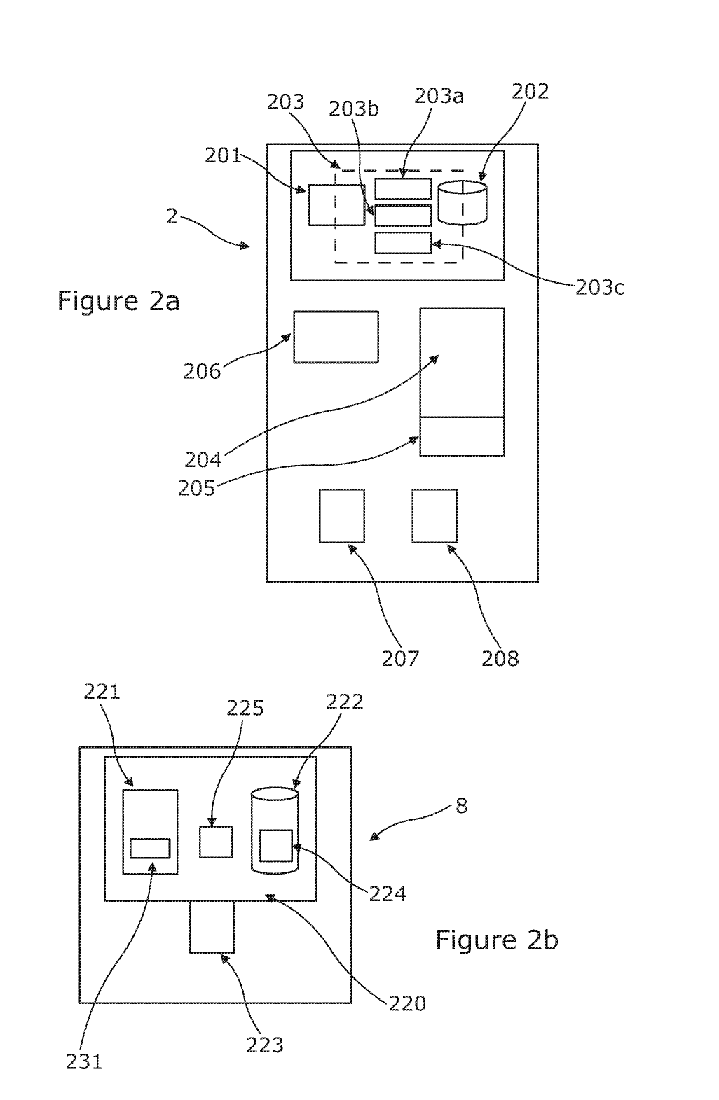

FIGS. 2a, 2b and 2c illustrate schematically relevant functions of a user mobile phone 2, a mobile services server 8 and an MPOS terminal 4.

FIG. 2a shows a mobile phone 2, though it should be noted that any other portable computing apparatus such as a laptop, notebook or tablet computer, or even a fixed apparatus such as a desktop computer, can be used as computing apparatus in embodiments of the disclosure. The mobile phone 2 is a host interacting with the mobile services server 8.

The mobile phone comprises a processor 201 and a memory 202, such that the memory stores and the processor will subsequently run applications (shown generally as application space 203) 203 such as a payment application 203a, a mapping application 203b and a banking location host application 203c. The mobile phone has a user interface comprising a display 204 and a touchscreen 205 (or other input device) and associated drivers to allow a user to enter data into and view information from the applications 203. The mobile phone 2 also has a cellular telecommunications capability, including subscriber information module 206 and wireless communication element 207 together providing the ability to connect to a cellular communications network.

The mobile phone may need to perform cryptographic operations in order to interact securely with a POS terminal—this may be achieved by a cryptographic capability within the subscriber information module 206, such as a cryptographic processor in a tamper resistant secure element or a trusted execution environment. Other approaches may be used such as white-box cryptography, which does not require the use of tamper resistant hardware. Alternatively, with the advent of tokenisation SUK (Single Use

Keys) could be loaded onto the handset to permit the generation of temporary tokens that represent a user's PAN in a random generated number sequence which has been cryptographically signed and can only be decrypted by an application with the appropriate keys. In such arrangements, cryptographic operations may not be performed on the device and instead it will merely act as a pass-through of tokens from device to server and return.

The mobile phone is here shown as having a local networking element 208 as well, in order to establish a short range wireless network connection—however, in other embodiments the mobile phone 2 may only be able to make network connections through a cellular telecommunications network. While a network connection is needed to enable communication between the computing device and the identity management service, this need not involve cellular telecommunications. For example, the computing device may be a tablet computer without cellular telecommunications capability but capable of making a local wireless network connection, and so a connection to the identity management service through the public internet.

FIG. 2b describes elements of the mobile services server 8. This is shown as comprising a server 220 with processor 221 and memory 222, with associated communications functionality 223. The communications functionality may include networking capability allowing communication with the payment network infrastructure 7, optionally there may be a telecommunications capability allowing communication over a telecommunications network with the mobile phone 2 and the MPOS terminal 4, although such communication may be entirely over data networks in which case no telecommunications capability at the mobile services server 8 would be required. The processor 221 is a representation of processing capability and may in practice be provided by several processors. The server provides at least a banking location server application 225 stored in the memory 222 and run on the processor 221, the memory 222 also storing at least an associated banking services database 224 (other features, such as a user database, are not shown explicitly here as they may be implemented by conventional means and do not need to be discussed further to explain the elements of the present disclosure). In embodiments, a cryptographic processor 231 may be used to enable secure communication between the mobile services server 8 and the mobile phone 2 and the MPOS terminal 4—alternatively, cryptographic methods may be used to without a specific cryptographic processor.

The banking location server application receives registration data and updated location data from the MPOS terminal 4 (or from associated computer devices), and serves banking location data to the mobile phone 2 for use in connection with the banking location application 23c at least.

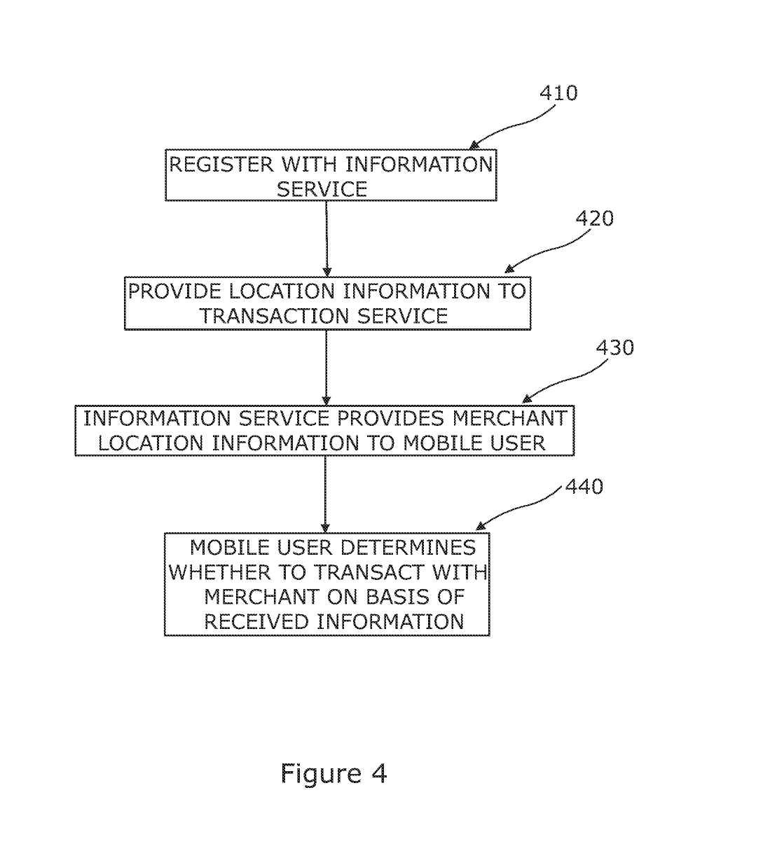

The banking location server application, providing information to its corresponding banking location host application on the mobile phone 2, comprises an exemplary information service of the type described below with reference to FIG. 4.

FIG. 2c illustrates the functional features of an MPOS terminal for use in embodiments of the disclosure in more detail. The MPOS terminal 4 has a processor 241 and associated memories 242. The base function of the terminal in the case shown is to operate as a point of interaction (POI) with a financial system—in the use cases described below, such a terminal may be a point of sale (POS) terminal, but in other embodiments it may be an automated teller machine (ATM), for example. In the case shown, the terminal 4 has an operating system 244 and transaction software 245 (these may be provided together in a single assemblage of code, or may both be divided into a number of different components, but are represented here as two elements for convenience) and also a location application 246. The operating system 244 manages hardware resources and provides common services for applications, whereas the transaction software 245 performs the base function of the terminal and may be provided (for example) as one or more applications. The location application 246 may receive information from within the MPOS terminal itself (for example from GPS receiver 256) or from or in connection with external sources, such as a computer physically associated with the MPOS terminal 8 or, but not limited to, from cellular network or local wireless network data . The terminal 8 will generally have a protected channel 247 to another party such as an acquiring bank (this may, for example, be realised over a public network by use of encryption). The terminal 8 will also have means to make a connection to a device such as a transaction card. In this case, the terminal has a contact card reader 257 and an NFC controller 258 and antenna 268 to allow a contactless card connection to a contactless card, or a device such as an NFC-enabled mobile handset for cellular telephony (hereafter “mobile handset”) able to act as a proxy for a contactless card. Transactions may be established through the contact card reader 257 or through the NFC controller 258, or indeed any other appropriate local connection.

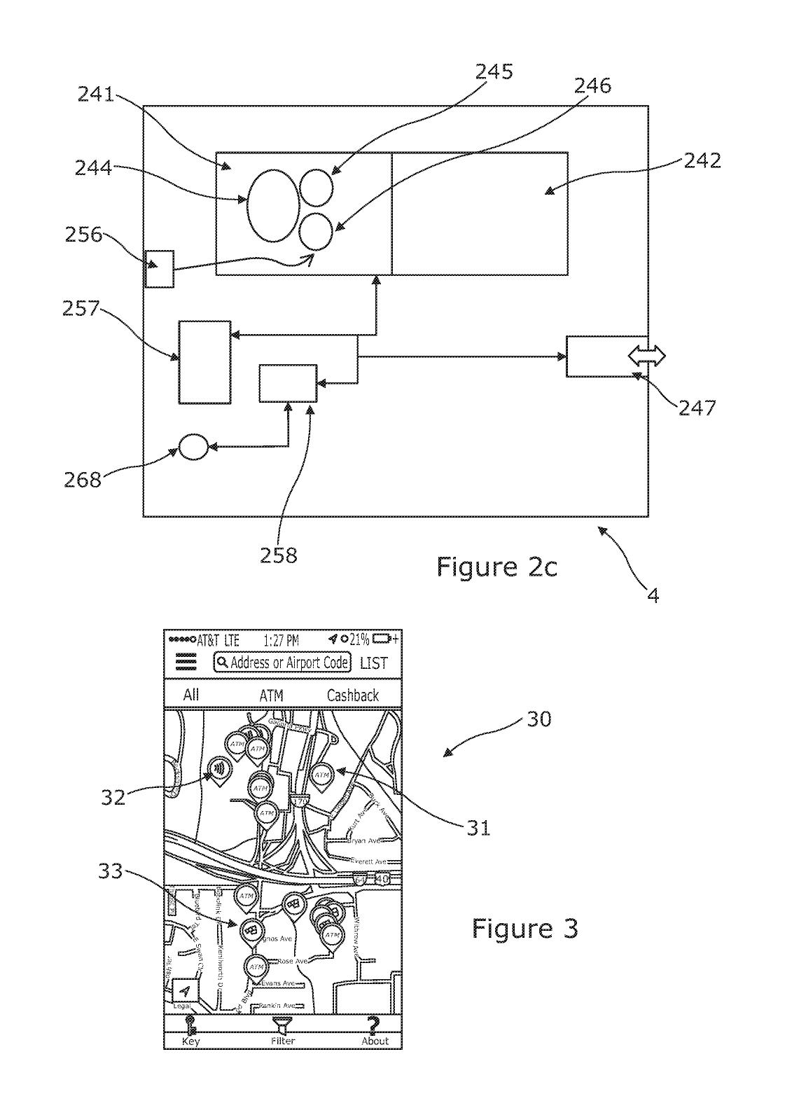

FIG. 3 shows a mobile phone user interface for a transaction service location application (such as MasterCard Nearby™). The user interface shown allows searching for specific destinations or items (or allows filtering so specific items are viewed), but shows transaction services of particular types on a map 30.

Elements shown here are ATMs 31, contactless payment merchants 32 and cashback locations 33 where cash may be obtained in the course of a transaction. Another possible item that may be shown in such an interface is a location where a prepaid card may gain additional credit. This transaction destination information may readily be combined with the mapping solution native to the platform (in the case shown, an Apple iPhone) to allow a user to navigate himself or herself efficiently to the correct location.

FIG. 4 describes a method according to a broad aspect of the disclosure. The method enables authentication of one or more parties to a transaction. Firstly, a first party (in embodiments, a merchant with an MPOS) registers 410 with an information service trusted by the first party and also by other parties (such as customers who may wish to transact with the merchant. The information service will also hold a credential for the first party, either received directly from the first party or from a trusted source (such as a merchant's acquiring bank). The first party then provides 420 its location data to the information service. When a second party wishes to transact with the first party, the information service provides 430 the location data and credential for the first party to the second party. The second party—typically a user of a mobile device, or in embodiments the device itself—can then determine 440 whether to transact with the first party on the basis of the received data.

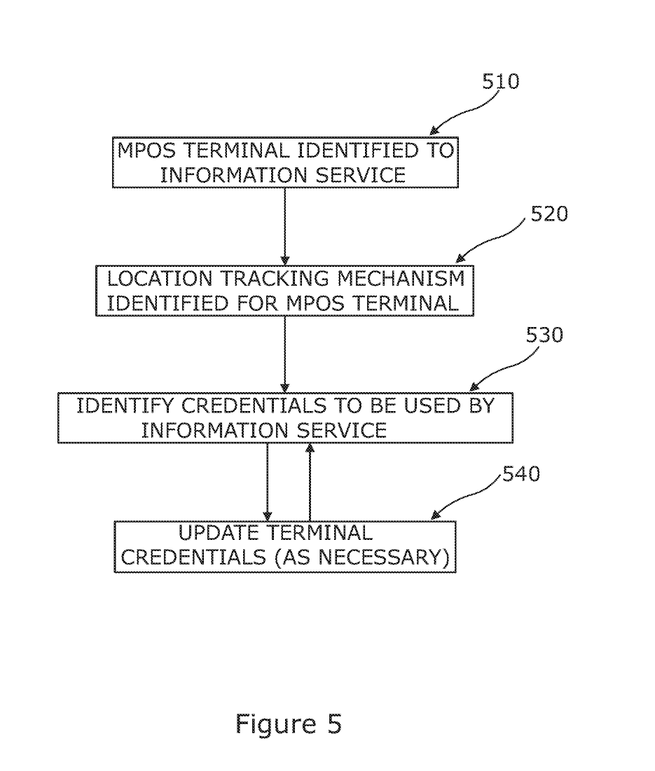

FIG. 5 illustrates a registration process for an MPOS terminal in one aspect of the disclosure. Other aspects of merchant registration and the assignment of an MPOS terminal to a particular merchant may be conventional and are not considered here—the following relates only to the registration of the MPOS terminal with the information service provided in aspects of this disclosure.

to Firstly, the MPOS terminal is identified 510 to the information service in such a way that the information service can establish that the MPOS terminal is legitimate and with its legitimate owner. This may require a cryptographic exchange involving communication between the MPOS terminal owner and the banking infrastructure (possibly routed through the acquiring bank of the MPOS terminal owner, possibly mediated through another part of the banking infrastructure, or possibly by a direct connection with the information service). A location tracking mechanism is then identified 520 for the MPOS terminal. If the MPOS terminal has a built-in location tracking mechanism—typically using one or more of GPS, cell identification and triangulation in a cellular network, and WiFi network location—then no positive location tracking means identification may be needed, but if these elements are not provided in the MPOS terminal itself, then these capabilities must be provided by another identified source associated (preferably physically associated) with the MPOS terminal, such as a cellular phone used with the MPOS terminal.

It is also desirable to identify 530 one or more credentials to be used by the information service. Such a credential may be a credential of, or a credential associated with, the MPOS terminal, or it may be a credential of or associated with the merchant associated with the MPOS terminal. The intention is that this credential or these credentials can be provided to the user by the information service together with location data, and that the provision of such credentials will allow the user to authenticate the MPOS terminal. It is therefore desirable for at least one such credential to be a visual credential, as this allows the user to use visual evidence as a basis for placing trust in the MPOS terminal. One such credential could be, but not limited to, a photographic image of the person manning the MPOS terminal. It is common in merchant operations to assign a particular till and POS machine to an operator, and the process of logging in a user to the merchant systems could be expanded so that the current user image was identified and forwarded to the information service. It therefore follows that in embodiments credentials may be updated regularly by merchants to reflect a current position, rather than being set for all time at registration. Initial registration may therefore be followed by a repeated step of updating 540 terminal credentials to reflect current conditions of use.

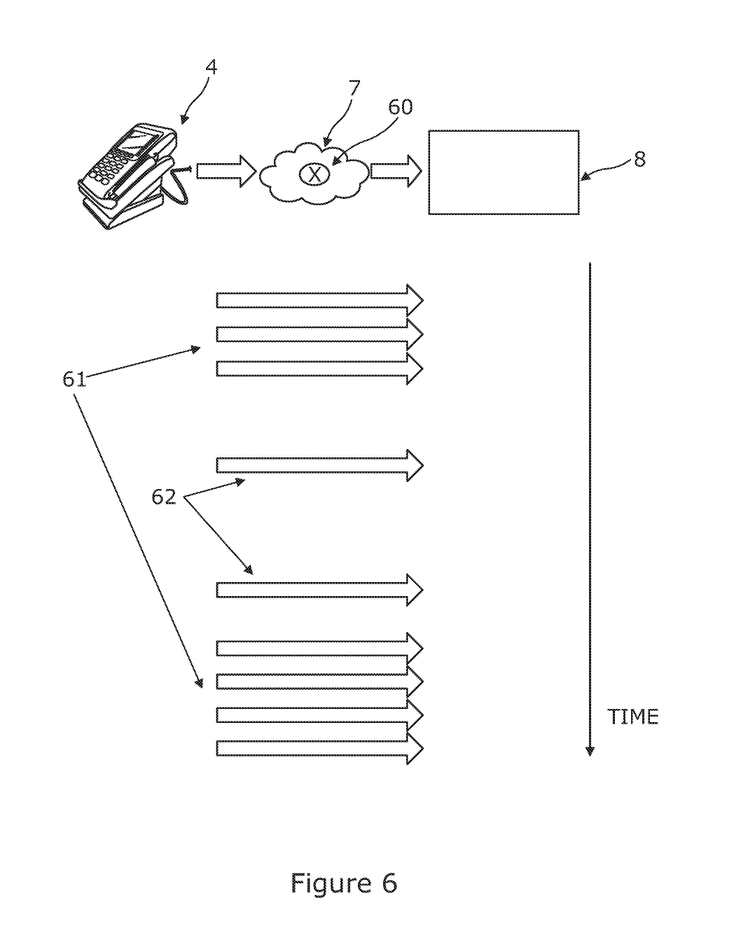

FIG. 6 illustrates monitoring of MPOS terminal position by an information service to associated with the banking infrastructure. This requires at least an intermittent connection of some kind between the MPOS terminal and the information service. Most conveniently, this is achieved by the communication path between the MPOS terminal and the banking infrastructure. In principle the communication between the MPOS terminal and the information service could be separate from the MPOS terminal's normal communication path to the banking infrastructure. Prevention of subversion may require either repeated secure interactions (such as a mutual authentication step) for every location update, or else only an initial mutual authentication for an extended session (which could result in management of a very large number of open sessions at the information service). By contrast, if the network communication and security protocols for the MPOS terminal to the banking infrastructure are used, location updates for the MPOS terminal may be provided with other banking infrastructure traffic and can be routed as appropriate in the banking infrastructure to the mobile services server.

This is the arrangement shown in FIG. 6. MPOS terminal 4 sends location updates (and, if desired, an updated credential) through the network infrastructure 7 to the information service 8. Within the network infrastructure 7 is a network switch 60 which is adapted to identify location update traffic and to forward it to the information service 8. Location update messages of two types are shown graphically against a time axis. A first type of location update message 61 is provided along with transaction data—in this case, the location update may simply be appended to transaction data sent in a message to the acquiring bank, and either the location update data is read by the network switch 60 and forwarded to the information service or else the acquiring bank in processing the conventional message identifies that there is a location update field and creates a new message for routing by the network switch 60. The second type of location update message is a dedicated message 62 provided when a conventional message with a location update has not been sent for a predetermined time. Again, this message is routed by network switch 60. While the message shown here is produced by the MPOS device, another possibility is for the information service to send a message to the MPOS device to indicate that the location has not been updated for some time, triggering a location update from the MPOS device. A further possibility would be for the information service 8 not to communicate details of an MPOS device which has not had a sufficiently recent location update, or else to communicate these in to such a way as to indicate to the mobile device or its user that the location data for the MPOS device was stale.

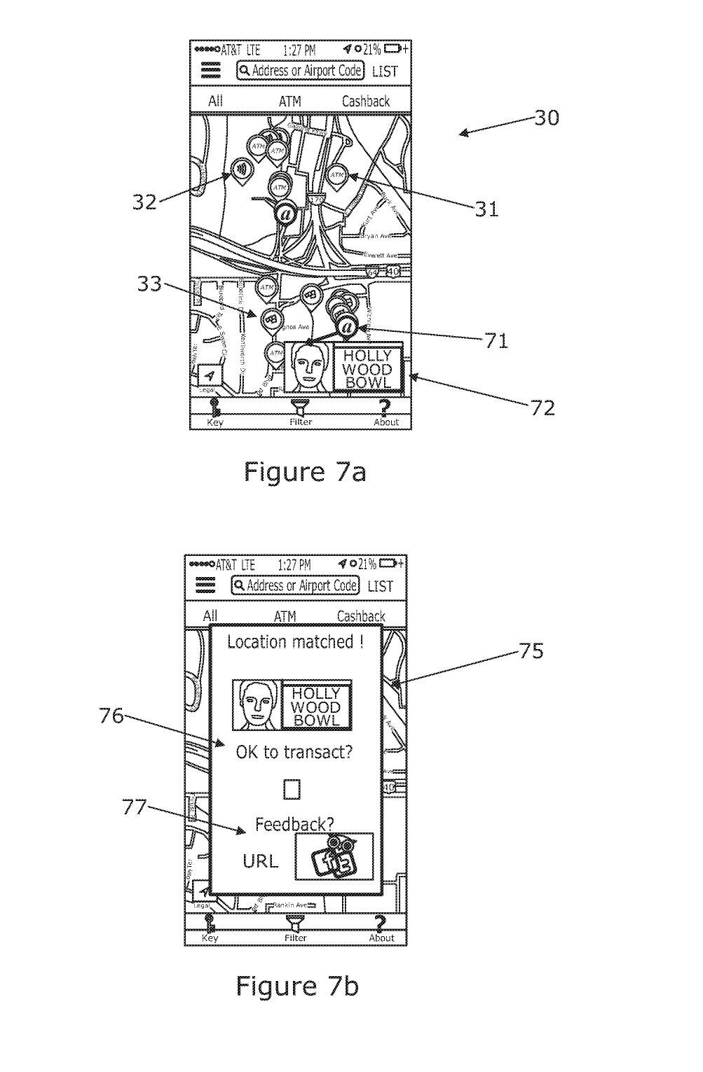

FIGS. 7a and 7b illustrate a mobile phone user interface for a transaction service location application accessing MPOS location data. The arrangement shown is a modification of the mobile phone user interface for a transaction service location application (such as MasterCard Nearby™) shown in FIG. 3.

FIG. 7a shows a display of nearby transaction service locations as shown in FIG. 3, but augmented by a further category of nearby MPOS terminals with credential data. A specific MPOS terminal 71 is shown as under review (typically after designation as a point of interest by a user touching the screen at or near that point) and an information window 72 is shown. The information window 72 shows credential data provided by the information service. In this case, this includes a photograph 73 of a person identified with the MPOS terminal at that time, and also text 74 (or other images) representative of the merchant.

FIG. 7b shows a further display screen which may be used in embodiments. In such embodiments, the mobile phone may determine that its own location matches the location provided by the information service for the MPOS terminal.

The transaction service location application may then provide a window 75 containing credential data as before, but also an invitation 76 to the user to initiate or enable a transaction, for example by enabling contactless payment from the mobile device. This screen may also be used as a mechanism to provide feedback 77 for a merchant—relevant details (such as merchant website URLs and links to the merchant's accounts with relevant social media such as Twitter, Facebook and TripAdvisor) may be included in the merchant's registration with the information service and so presented in this way at the time of transaction. Preferably (as discussed below) the transaction service location application will also log transactions carried out to include the merchant's social media links, enabling social media feedback to be made after the transaction at a time convenient for the user. Integration of social medial feedback with transaction location is discussed further below. Location-based loyalty schemes could be positioned using the location data provided and offer the user the best possible pricing for the product or service they are intending on purchasing.

Location matching could be used in a number of different ways in embodiments. For example, a transaction could be only authorised with an MPOS device if the mobile device and the registered MPOS device are co-located, or an additional permission step may be required if there is not determined to be a location match that is not required if a location match to a registered MPOS device is detected.

Another possibility may be to allow conventional transactions if no location match is determined, but to allow contactless transactions if there is a location match. All these options are considered layers of security which can be added in to a solution depending on how secure the issuing/acquiring bank would like to make it.

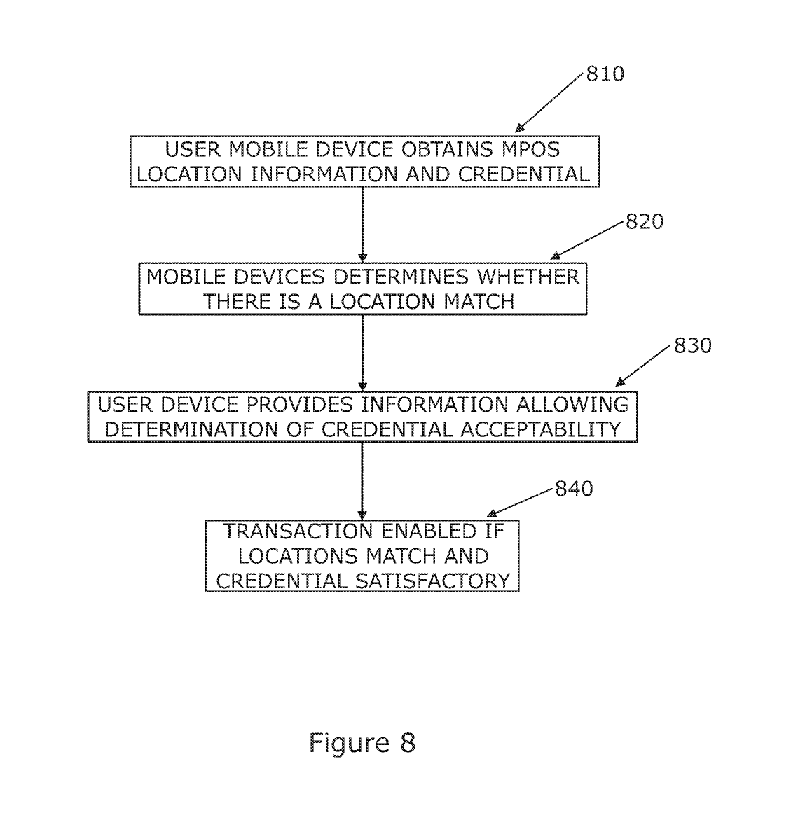

FIG. 8 illustrates steps in a transaction between a mobile user and an MPOS terminal according to an aspect of the disclosure.

It is assumed that the relevant application (in embodiment discussed above, the transaction service location application) is active and that the MPOS terminal is selected or otherwise satisfies relevant criteria for active consideration. The user mobile device then obtains 810 location data and a credential for the point-of-sale terminal from a remote trusted source.

Once location data for an MPOS terminal of interest has been received, the user device determines 820 whether or not there is a match between a user location and the point-of-sale terminal location. The credential also needs to be evaluated—in one arrangement, the user device provides an indication to a user to allow user determination of whether the credential is satisfactory, but in other approaches the user device may determine itself whether the credential is satisfactory and merely provide confirmation of this to the user.

The transaction may then be enabled 840 if the user location and the point-of-sale terminal location match, and if the credential is determined to be satisfactory. As discussed above, this may in some embodiments be a decision for the user when presented with both location match and credential data, in others may be made automatically by the device (if equipped to evaluate the credential), and in yet others the path to enablement of the transaction may vary depending on whether or not there is a match in location and satisfactory credential data.

As noted above, this approach and the information exchange associated with it can be used for more than immediate location of legitimate MPOS terminals and authentication for transaction purposes—it may also be integrated more generally with social media and in particular merchant rating. For this to be done, if the user wishes to retain this data, it may be possible not only for the mobile device to hold a transaction history (as will normally be the case for any transaction application) but also to keep historical details of interaction with merchant terminals registered with the information service. It is important that any implementation of this approach should comply with applicable data privacy laws, and that the user (and any user affected) will only provide private, personal or sensitive data on any form of log with full consent. It should be noted that this may have value even if the merchant terminal is not an MPOS terminal—while there may not be the same need for the mobile device user to establish that the terminal is legitimate, the mechanism can still provide a particularly effective way to log user feedback and to provide extra functionality and value for the user and merchant.

One approach is simply to augment existing transaction histories with feedback data as shown in FIG. 7b. One further possibility is for a separate terminal co-location history to be stored, including not only transactions but also cases where there was co-location but where no transaction was made (the user may still wish to rate such merchants)—however, as this provides a track of user location, it should be considered information sensitive to the user. In addition, with specific user consent, the merchant may also log user details in a transaction to build up a history of a user using a specific merchant terminal. This may allow a merchant to present the user with offers specific to that user and rewards based upon use of that store (that merchant terminal or group of merchant terminals).

Using such data, a user can work through their shopping experience to provide ratings of different merchants, feeding these back either directly to the different linked social media applications (e.g. by providing a rating in TripAdvisor directly), or possibly through a consolidated feedback mechanism that provides feedback to each social network that the user desires to use. User rewards may be provided by the merchant to the user on establishment of social media connections between user and merchant in a to conventional way, but these could be modified or augmented in the light of actual transaction history. Loyalty schemes could align the feedback mechanism with the social media providers to drive proactive rating/reviewing for transactions.

While discussion here has generally been related to banking location server and host applications as an instantiation of an information service providing location data, aspects of the disclosure may employ information services of other types not directly associated with banking transactions. Locations of other types (such as transport hubs) and users of other types (such as registered users of a transport system) may be used in location based information services of comparable types.

As the person skilled in the art will appreciate, modifications and variations to the above embodiments may be provided, and further embodiments may be developed, without departing from the spirit and scope of the disclosure. Reference to standards and proprietary technologies are provided for the purpose of describing effective implementations, and do not limit the scope of the disclosure.

1. A computer implemented method of authenticating one or more parties to a transaction, comprising:
registering at least a first party to the transaction with an information service trusted by the first party and a second party, whereupon the information service holds credential data for the first party;
providing location data for the first party to the information service; and
when the second party wishes to transact with the first party, the information service providing the location data for the first party and the credential data for the first party to the second party.

2. The method of authenticating of claim 1, wherein the first party comprises a mobile point-of-sale terminal.

3. The method of authenticating of claim 1, wherein the location data is provided by one or more of GPS, cellular telephony cell data and local wireless network location data associated with the first party.

4. The method of authenticating of claim 1, wherein the second party comprises a mobile computing device or a mobile handset.

5. The method of authenticating of claim 4, wherein the location data is provided for use to illustrate a map location for the first party.

6. The method of authenticating of claim 4, wherein the location data is used to determine when the first party and the second party are co-located.

7. The method of authenticating of claim 6, wherein a transaction prompt is provided when it is determined that the first party and the second party are co-located.

8. The method of authenticating of claim 1, wherein the credential data is displayable as a visual indicator, and wherein the visual indicator is a picture of a person associated with the first party.

9. The method of authenticating of claim 1, wherein the information service also holds social media data for the first party and provides the social media data when providing the location data and the credential data.

10. The method of authenticating of claim 2, wherein the second party comprises a mobile computing device or a mobile handset.

11. The method of authenticating of claim 10, wherein the location data is used to determine when the first party and the second party are co-located.

12. A method for a user mobile device to enable transaction with a point-of-sale terminal, wherein the user mobile device is a mobile computing device or a mobile handset, the method comprising:
the user mobile device obtaining location data and credential data for the point-of-sale terminal from a remote trusted source;
the user device determining a match between a user location and the point-of-sale terminal location, and the user device providing an indication to a user to allow user determination of whether the credential data is satisfactory; wherein
the transaction is enabled if the user location and the point-of-sale terminal location match and the credential data is determined to be satisfactory.

13. The method for a user mobile device as claimed in claim 12, wherein the point-of-sale terminal location is shown on a local transaction services map.

14. The method for a user mobile device as claimed in claim 12, wherein the credential data is a visual indicator, and wherein the visual indicator is a picture of a person associated with the point-of-sale terminal.

15. The method for a user mobile device as claimed in claim 12, wherein with the location data the user mobile device receives social media data associated with the point-of-sale terminal.

16. The method for a user mobile device as claimed in claim 12, wherein the user mobile device stores a transaction history including information to identify the point-of-sale terminal.

17. The method for a user mobile device as claimed in claim 16, wherein with the location data the user mobile device receives social media data associated with the point-of-sale terminal and wherein the social media data associated with the point-of-sale terminal is stored in the transaction history.

18. A point-of-sale terminal comprising a mobile point-of-sale device, wherein the point-of-sale terminal is registered with an information service to provide transaction service location data and credential data for the mobile point-of-sale device to users, and wherein the point-of-sale terminal is adapted to provide location data for the mobile point-of-sale device to the information service.

19. A point-of-sale terminal as claimed in claim 18, wherein the point-of-sale terminal is also adapted to provide updated credential data to the information service after registration with the information service.

20. A method for enabling social media reviews at a user mobile device, comprising:
the mobile user device receiving information comprising location data and social media data for a merchant from an information service and displaying the merchant on a transaction services map,
the mobile user device performing or enabling a transaction using the information received from the information service to perform a transaction, and recording the transaction in a transaction history together with the social media information for the merchant, and
presenting the transaction history to a user of the user mobile device to allow the user to provide a social media review of the merchant using the social media data for the merchant.
